(19) United States
(12) Patent Application Publication
(10) Pub. No.: US 2006/0154001 A1
(43) Pub. Date: Jul. 13, 2006

(54) Ink-jet recording material

(75) Inventor: Alain Dominique M Sismondi, Cairo Montenotte (IT)

Correspondence Address: Mark A Litman & Associates;York Business Center, 3209 West 76th ST, Suite 205, Edina, MN, 55435, US

(73) Assignee: Fitra Investimenti S.p.A., Savona (IT)

(21) Appl. No.: 10/542,532

(22) PCT Filed: Jan. 12, 2004
(86) PCT No.: PCT/EP04/00131

§ 371 Date: Jul. 15, 2005

(30) Foreign Application Priority Data
Jan. 17, 2003 (IT) SV2003 A 000001

(51) Int. Cl. B41M 5/00

(52) U.S. Cl. 428/32.1

(57) ABSTRACT

The present invention refers to an ink-jet recording material having at least one porous ink receiving layer comprising alumina particles, a binder resin, boric acid or borate, and a color fading inhibitor compound of the following Formula (I) wherein R₁ to R₁₀, being the same or different, each is an alkyl group having from 1 to 5 carbon atoms; X is a divalent linking group; m and n, equal or different, are 0, 1 or 2; Z is Y or is an alkyl group having from 1 to 12 carbon atoms, and Y is represented by formula (II), wherein R₁₁, and R₁₂ each being an alkyl group having from 1 to 6 carbon atoms, said ink-jet recording material being substantially free of thiocyanate compounds. The invention also revers to the use of an ink-jet recording material as described above, to improve the gas resistance, of the images recorded on it.

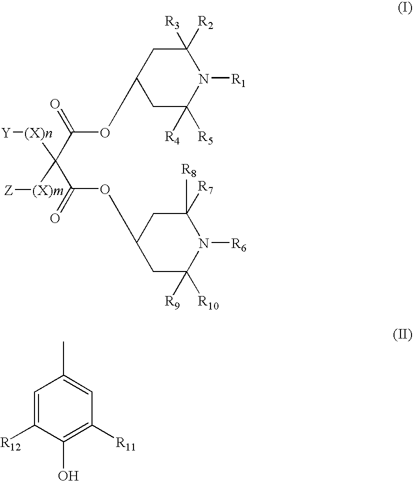

### FIELD OF THE INVENTION

The present invention refers to a microporous ink-jet recording material comprising at least one porous ink receiving layer containing alumina particles, a binder, boric acid or borate, and a color fading inhibitor compound.

### BACKGROUND OF THE ART

In recent years, the use of ink-jet system to generate images has rapidly growth. The improvement in both printers and inkjet recording media performances allows to obtain images similar to conventional silver halide photographic ones. At the same time, due to spreading speed increase in printing systems, there is the need to use recording media able to absorb all ink volumes in very short time. The ink high speed absorptivity can be achieved using an ink-jet recording material comprising a porous layer which is able to rapidly remove the fresh spread ink from the surface of the material, while the absorption capacity can be adjusted varying the thickness of the receiving layer.

Even if the ink-jet record materials having porous layers present a better ink absorptivity than ink-jet record materials utilizing swelling system layers, the images printed on porous system may suffer of oxidation deterioration of coloring matter component under natural air exposure. The gas circulation in porous materials supplies a continuous flux of oxidizing compounds, such as nitrogen oxides, sulfur oxides, oxygen or ozone gas, that are directly in contact with the coloring matter in the porous layer. Accordingly, images obtained by ink-jet recording materials have inferior properties in terms of storage characteristics, such as light resistance, water resistance and gas resistance, compared to images obtained by silver halide photographic materials.

Various attempts have been done in the art to solve said color fading problem; in some cases, a color fading inhibitor compound has been added to the ink composition. European Patent 875,544, for example, discloses an ink composition comprising a colorant, water, a water-soluble organic solvent, and a fine particle of a polymer, the polymer constituting the fine particle having a film-forming property and, at the same time, an ultraviolet absorbing capacity and/or a light stabilizing capability; Japanese Patent application 11-315,234 discloses an ink composition containing a triazine compound and a sterically hindered amine compound; Japanese Patent application 05-239,389 discloses a recording liquid comprising a dye, pure water and a light stabilizer capable of obtaining high-grade stabilized images.

An other way of solving the problem consists in adding the color fading preventing compound in the base of the ink receiving material; in fact, U.S. Pat. No. 6,171,751 incorporates a sterically hindered amine light stabilizer in the resin polypropylene support layer; EP 1,205,312 discloses a recording medium comprising a base material, and at least one resin selected from a primary amine resin and a secondary amine resin and a sterically hindered amine compound contained in the base material, and EP 1,138,514 discloses a recording material comprising a support coated with a layer containing a light resistance-imparting chemical and an image-forming layer free of a light resistance-imparting chemical in that order.

As other kind of solution, a transferring protective covering material comprising a fluorescent whitening agent, an ultraviolet light absorber, and a light stabilizer to cover a printed image is disclosed in U.S. Pat. No. 4,756,963; U.S. Pat. No. 5,954,906 discloses a transferring protective covering material comprising a flexible substrate, an adhesive layer containing a light stabilizer and a solid resin layer. As protective member, EP 1,221,381 discloses a recorded matter having an ink-receiving layer of a porous structure, wherein the ink-receiving layer has an image region where an image is formed with a coloring material, wherein the image region has a portion in which all or substantially all of the coloring material distributing in a thickness direction of the ink-receiving layer are embedded in a non-volatile liquid which does not dissolve the coloring material. EP 1,186,439 discloses a surface treatment method for recorded matter, such as images recorded on a recording medium and the recording medium that contains such images, which can improve the weather characteristics of the images, such as light resistance and gas resistance. Said method is characterized by subjecting said recorded matter to an after-treatment, such as spray treatment, coating treatment, immersion treatment, to form an overcoat layer applied onto the surface of the recorded matter. This overcoat layer contains an aqueous solution containing a water-soluble resin, a light resistance improving agent and an ink fixing agent; the overcoat layer protects the surface of said recorded matter preventing the gas present in the air to penetrate into the recorded matter, and thus improving the color fading due to light and gas presence. The color fading improving agent disclosed in said patent remains on the protective layer obtained by the after-treatment method described above and overcoated onto the surface of the recorded matter, without penetrating into the internal layers of the recorded matter. However, this solution has the disadvantage that an after-treatment involving the use of a treatment agent is required; this means that said treatment agent must be incorporated into an additional composition to form the protective layer to be sprayed or coated onto the surface of the recorded matter, with the consequent problems related to choose the proper elements contained in said additional composition, how to introduce and mix them, how to store and treat the final composition, and so on. Hence, it would be preferable to add the color fading inhibitor compounds directly into the ink receiving layers of the recording elements, without the need to prepare any additional compositions to be sprayed or coated onto the recorded matters.

The use of conventional antioxidant compounds provide a limited protection in the time that is vanished when the compound is consumed. Most of natural or synthetic antioxidants, like vitamin C, vitamin E, substituted hydroquinone, exhibit positive activity to prevent image discoloration due to oxidation, but have the disadvantage of generating colored substances, as reaction products, that visibly modify the printed image. The most common observation is a yellowing change in both the printing and the non printing areas of image.

EP 1,120,281 discloses an ink-jet recording material comprising pigment particles dispersed in a binder with average particle size of 1 micron or less. Said ink receiving layer comprises light resistant enhancing agents for image selected from phenolic compounds, boric acid, borate salts and cyclodextrin compounds. Comparative examples shows that the substitution of a phenolic compound with the Tinuvin™144 sterically hindered amine compound exhibited an unsatisfactory light resistance of the recorded images. EP 1,008,457 and U.S. Pat. No. 6,391,428 disclose an ink-jet recording sheet having an image preserving layer comprising anionic colloidal silica and zinc oxide particles; said ink receiving layer also comprises specific sterically hindered amines compounds having alkoxy groups, but comparative examples, wherein said specific sterically hindered amine compounds have been replaced by Tinuvin™144 sterically hindered amine compound, an improvement in light resistance has been not showed.

WO 2002-055,618 discloses the use of specific water soluble sterically hindered amine compounds which contain an oxyl or hydroxyl group on the nitrogen atom and which does not contain a sterically hindered phenol moiety in its chemical structure. EP 1,031,431 discloses a recording medium comprising a specific sterically hindered amine compound having an alkyl group bonded to nitrogen atom of a piperidine ring with interposition of oxygen; no sterically hindered phenol moieties are present in its chemical structure. EP 1,134,087 discloses a recording medium comprising an ink receiving layer containing specific sterically hindered amine compounds exhibiting solubility in water of 0.01 to 5%; no sterically hindered phenol moieties are present in the chemical structure of said compounds. Japanese Patent applications 61-146,591; 11-245,504 and 2000-247,015 describe recording sheets containing specific sterically hindered amine compounds, not containing sterically hindered phenol moieties in their chemical structures, which show 30, improved light fastness and water resistance.

Some other patents discloses the combination of compounds added into the porous ink receiving layer. In fact, JP 2000-238,421 discloses sterically hindered amine with molecular weight of 1000 or below combined with thiocyanate salt in porous layer to reduce the grade of color fading in an acceptable range, while each single component, thiocyanate salt or the same sterically hindered amine alone, exhibits an unacceptable color fading. JP 2001-121,807 describes the combination of said thiocyanate and sterically hindered amine in an ink acceptance layer based on silica-alumina composition. However, even if the combined use of sterically hindered amines and thiocyanate compounds reduces the problem of color fading, such a combination is not useful due to the fact that it visibly modifies the colored printed images; in particular, an undesired yellowing change in both the printing and the non printing areas of image is generated. EP 685,345 discloses a recording sheet which comprises a substrate and a porous ink-receiving layer containing at least one compound selected from the group consisting of dithiocarbamates, thiurams, thiocyanate esters, thiocyanates formed on the substrate to provide a recording sheet which is excellent in the ink absorptivity and also in the property for fixing a colorant and which is free from color-fading of images during the storage after printing for a long period of time; the combination of thiocyanate and sterically hindered amines is also disclosed. JP 2001-121,812 discloses the use of an acid and a sterically hindered amine onium salt on a porous ink acceptance layer to reduce color fading. It is showed therein that a sterically hindered amine alone does not give an acceptable improvement in color fading, while the onium salt of the same sterically hindered amine gives an acceptable improvement. JP 3-013,376 discloses an ink-jet recording material containing both a sterically hindered phenol compound and a sterically hindered amine compound in a weight ratio of 1/9-7/3. Other combinations are described in EP 1,180,436 which discloses polyurethane resin with a pigment containing phenolic antioxidant and a sterically hindered amine compound, and in JP 2001-301,323, wherein a recording material with a porous ink receptor layer containing a quenching agent consisting of iodine or iodine in combination with sterically hindered amine is described.

### SUMMARY OF THE INVENTION

The present invention refers to an ink-jet recording material having at least one porous ink receiving layer comprising alumina particles, a binder resin, boric acid or borate, and a color fading inhibitor compound of the following Formula I:

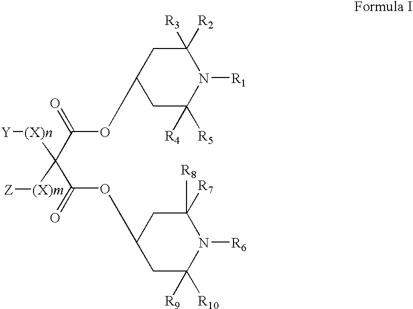

wherein R₁ to R₁₀, being the same or different, each is an alkyl group having from 1 to 5 carbon atoms; X is a divalent linking group; m and n, equal or different, are 0, 1 or 2; Z is Y or is an alkyl group having from 1 to 12 carbon atoms, and Y is represented by formula II, 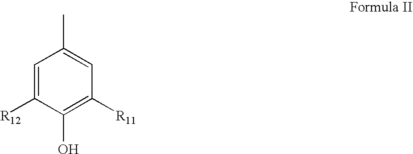
wherein R₁₁, and R₁₂ each being an alkyl group having from 1 to 6 carbon atoms, said ink-jet recording material being substantially free of thiocyanate compounds.

The color fading inhibitor compounds of Formula I are suitable to improve the weather storage characteristics over time, such as gas resistance, preventing oxidation deterioration of coloring matter component of the printed image during long term exposure to natural air. In addition, the ink-jet recording material of the present invention allows to obtain colored printed images which are not altered over the time, i.e. a yellowing change is not noted in the printed or not printed images.

The invention also refers to the use of an ink-jet recording material as described above, substantially free of thiocyanate compounds, to improve the weather characteristics, such as gas resistance, of the images recorded on it.

### DETAILED DESCRIPTION OF THE INVENTION

In previous Formula I, R₁ to R₁₀, being the same or different, each represents a straight or branched alkyl group having from 1 to 5 carbon atoms, such as, for example, methyl group, trifluoromethyl group, ethyl group, propyl group, isopropyl group, butyl group, tert.-butyl group. Preferred examples of alkyl groups represented by R₁ to R₁₀ are methyl groups or ethyl groups.

X, when present, is a divalent linking group, such as, for example, straight chain, branched chain or cyclic alkylene, arylene, aralkylene, oxy, oxo, thio, sulfonyl, sulfoxy, amino, imino, sulfonamido, carbonamido, carbonyloxy, urethanylene and ureylene groups and combinations thereof such as sulfonamidoalkylene or carbonamidoalkylene; m and n, equal or different, are 0, 1 or 2. Preferred examples of divalent linking groups are alkylene groups.

Z can be represented by Formula II or by an alkyl group having from 1 to 12 carbon atoms, such as, for example, methyl group, trifluoromethyl group, ethyl group, propyl group, isopropyl group, butyl group, tert.-butyl group, pentyl group, octyl group, nonyl group. Preferred examples of alkyl groups represented by Z are alkyl groups having from 1 to 6 carbon atoms.

In previous Formula II, R₁₁ and R₁₂, being the same or different, each represents a straight or branched alkyl group having from 1 to 6 carbon atoms, such as, for example, methyl group, trifluoromethyl group, ethyl group, propyl group, isopropyl group, butyl group, tert.-butyl group, pentyl group, hexyl group. Preferred examples of alkyl groups represented by R₁, and R₁₂ are methyl groups, ethyl groups, butyl group or tert.-butyl groups.

Preferred color fading inhibitor compounds useful in the present invention are represented by the following Formula III:

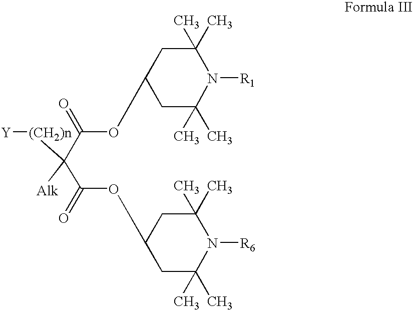

wherein, Y, R₁ and R₆ are as above and Alk is an alkyl group having from 1 to 12 carbon atoms, such as, for example, methyl group, trifluoromethyl group, ethyl group, propyl group, isopropyl group, butyl group, tert.-butyl group, pentyl group, hexyl group. Preferred examples of alkyl groups represented by Alk are alkyl groups having from 1 to 6 carbon atoms, such as, for example are methyl groups, ethyl groups, butyl group or tert.-butyl groups.

When in the present invention the term “group” is used to define a chemical compound or substituent, the described chemical material comprises the basic group, ring or residue and that group, ring or residue with conventional substitutions. When on the contrary the term “units” is used, only the chemical unsubstituted material is intended to be included. For instance, the term “all group” comprises not only those alkyl units such as methyl, ethyl, butyl, octyl, stearyl, etc., but even those units bearing substituents such as halogen atoms, cyano, oxydryl, nitro, amino, carboxilate groups. The term “alkyl units” on the contrary comprises only methyl, ethyl, stearyl, cyclohexyl.

Examples of color fading inhibitor compounds useful in the present invention are represented, but not limited to, by the following examples.

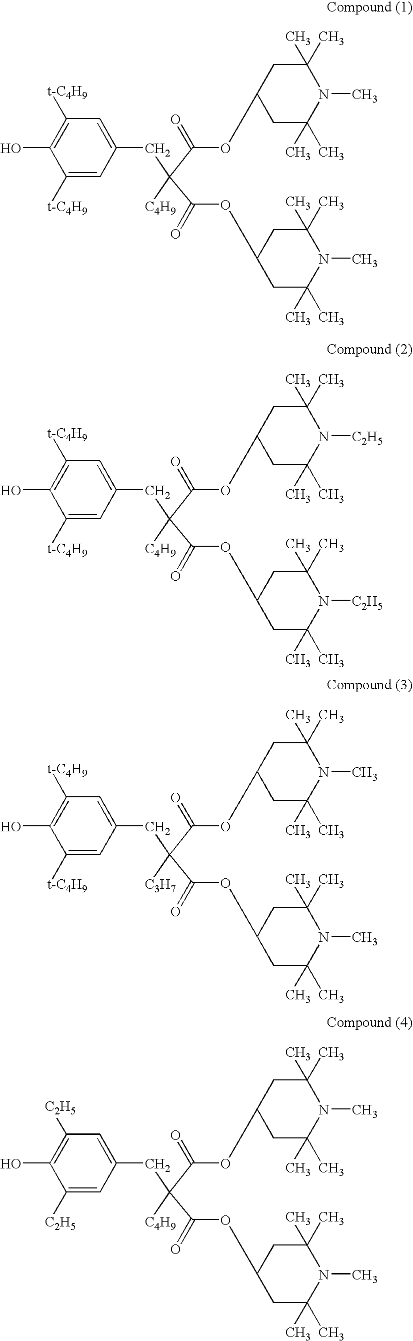

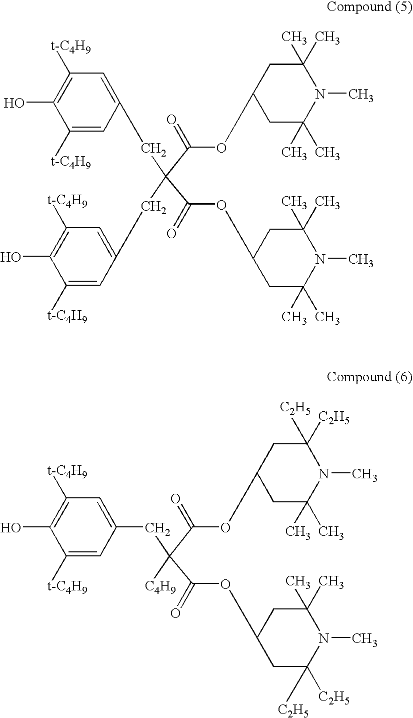

The color fading inhibitor compounds useful in the present invention are commercially available, for example, from Ciba Specialty Chemicals Inc, Basel, Switzerland. Their solubility in water is lower than 0.01%. They are incorporated into a solution, dispersion or emulsion used for forming the porous ink-receiving layer of the ink-jet recording material of the present invention by one of the incorporating methods known in the art, such as, for example, milling or grinding techniques, e.g., ball-milling, sand-milling or colloid-milling the compounds in the presence of a dispersing agent; oil-in-water dispersion method or loaded particle latex techniques, such as those described in Research Disclosure, Item 19551, July, 1980; or by using micro-precipitation techniques to form micro-particulates of said water insoluble color fading inhibitor compound in a water system; or by dissolving them in alcohol solution including, for example, hydrochloric acid, nitric acid, sulfuric acid, sulfurous acid, hydrogen sulfide, perchloric acid, hydrogen peroxide, carbonic acid, a carboxylic acid, such as formic acid and acetic acid, a substituted carboxylic acid, a sulfonic acid such as benzenesulfonic acid; an halogen boric acid such as tetrafluoroboric acid; or by dissolving it in acid solution including amphoteric and/or cationic and/or non-ionic surfactants.

The dry content of the color fading inhibitor compound in the coating dispersion is preferably from 0.1 to 10 weight %, more preferably from 0.3 to 5 weight %. The amount of the color fading inhibitor compound contained in the ink-jet receiving layer used in the present invention is generally in the range from 0.1 to 5.0 g/m², preferably from 0.3 to 4 g/m², most preferably from 0.5 to 3 g/m². The amount of said color fading inhibitor compound is preferably from 0.5 to 15 weight %, more preferably from 1 to and 10 weight % respect to the amount of alumina particles present in the ink-jet receiving layer.

The alumina particles present in the ink-jet receiving layer are alumina hydrate compounds that may be represented by the formula Al₂O₃.nH₂O; specifically, the alumina hydrate may be, for example, gibbsite, bayerite, nordostrandite, boehmite, diaspore or pseudoboehmite. Alumina hydrate, and in particular boehmite or pseudo-boehmite, (wherein n is from 1.0 to 2.0) is preferably used in the inkjet recording material of the present invention.

Said alumina hydrate, as described for example in EP patent application No. 636,489, can be produced by any conventional method such as the hydrolysis of aluminum alkoxide or sodium aluminate. Rocek, et al. [Collect Czech. Chem. Commun., Vol. 56, 1253-1262 (1991)] have reported that the pore structure of aluminum hydroxide is affected by deposition temperature, pH of the solution, aging time and surfactants used. The shape of the alumina hydrate used in the present invention can be in the form of a needle or in the form of a flat plate (as described in the literature by Rocek J., et al., Applied Catalysis, Vol. 74, 29-36 (1991), the latter being particularly preferred for the reasons that better dispersibility can be obtained and because the orientation of particles of the alumina hydrate in the form of a flat plate becomes random when forming an ink-receiving layer, so that the range of the pore radius distribution widens. The average particle diameter of the alumina hydrate is preferably in the range from 10 to 200 nm, preferably from 50 to 150 mm.

The BET specific surface area of the alumina hydrate was calculated in accordance with the method described in Brunauer, et al., J. Am. Chem. Soc., Vol. 60, 309 (1938). The BET specific surface areas may preferably be within a range of from 70 to 300 m²/g, more preferably in the range from 100 to 250 m²/g. If the BET specific surface area is greater than the upper limit of the above range a dye in an ink cannot be fully adsorbed and fixed. On the other hand, specific surface areas smaller than the lower limit of the above range result in failures to apply the pigment with good dispersibility and hence to control the pore radius distribution.

The pore radius and pore volume of the alumina hydrate were calculated in accordance with the method described in Barrett, et al., J. Am. Chem. Soc., Vol. 73, 373 (1951). The average pore radius of the alumina hydrate preferably is in the range of from 2 to 100 nm, more preferably from about 5 to about 50 nm, most preferably from 5 to 30 nm. According to the present invention, particularly useful alumina hydrate has a pore radius maximum within a range of from 9 to 12 nm in a pore radius distribution of the fine powder material and a total volume of pores having radii not exceeding 5 nm is not more than 10% of a volume of all pores of the fine powder material.

The pore volume of the alumina hydrate is preferably within a range of from 0.3 to 1.0 ml/g, more preferably from 0.7 to 1.0 ml/g. If the pore volume of the alumina hydrate is greater than the upper limit of the above range, cracking and dusting occur on the ink-receiving layer. If the pore volume is smaller than the lower limit of the above range, the resulting recording medium is deteriorated in ink absorption capability.

In the present invention, the dry content of the alumina particles in the coating dispersion is preferably from 10 to 95 weight %, more preferably from 15 to 90 weight %; the ink-receiving layer preferably comprises from 10 to 80 g/m², more preferably from 15 to 60 g/m² of alumina particles. The solvent is preferably water. The binder resin in the ink-receiving layer may be, for example, polyvinyl alcohol, silanol modified polyvinyl alcohol, polyvinyl acetate, oxidized starch, etherified starch, a cellulose derivative such as carboxymethyl cellulose or hydroxyethyl cellulose, casein, gelatin, acidic gelatin, soybean protein or, maleic anhydride resin, a copolymer latex of conjugated diene type such as a styrene-butadiene copolymer or a methylmethacrylate-butadiene copolymer; an acrylic polymer latex of acrylic type such as a polymer or a copolymer of acrylic ester or methacrylic ester, or a polymer or a copolymer of acrylic acid or methacrylic acid; a polymer latex of vinyl type such as an ethylene-vinyl acetate copolymer; a polymer latex of functional group modified type by a monomer containing functional groups such as a carboxyl group of such polymers; an aqueous adhesive of thermosetting synthetic resin such as an urea resin or a melamine resin; a synthetic resin type adhesive such as polymethyl methacrylate, a polyurethane resin, an unsaturated polyester resin, a vinyl chloride-vinyl acetate copolymer, a polyvinyl butyral or an alkyd resin. These resins may be used alone or in combination as a mixture. Further, known natural or synthetic resin binders may be used alone or in combination as a mixture. Among the above-mentioned binder resins, particularly preferred are polyvinyl alcohols; in particular, more preferred binder resins are polyvinyl alcohols having a saponification degree lower than 90%, where the saponification degree is defined by the formula (A×100)/B, wherein A is the number of free hydroxyl groups in the polyvinyl alcohol and B is the total number of ester groups capable of saponification and of free hydroxyl groups in the polyvinyl alcohol. A saponification degree lower than 90% means that a partial saponification degree occurred, compared with the almost completely saponification when such value is around 98-100%. Preferably, the polyvinyl alcohol has a polymerization degree equal to or lower than 1500.

The dry content of binder resin in the coating dispersion is preferably in the range from 0.5 to 30 by weight %, more preferably from 1 to 25 by weight %. The ink-receiving layer preferably comprises from 1 to 10 g/m², more preferably from 2 to 8 g/m² of binder resin. The content of the binder resin is preferably from −1 to 50 parts by weight, more preferably from 2 to 25 parts by weight, per 100 parts by weight of the fine alumina particles present in the ink-jet receiving layer. If the amount of the binder is less than the above range, the mechanical strength of the alumina particles layer tends to be inadequate. On the other hand, if it exceeds the above range, ink-absorptivity of the alumina particles layer tends to be impaired.

The ink-receiving layer of the recording material of the present invention also contains boric acid or a borate. As the boric acid, not only orthoboric acid but also metaboric acid and hypoboric acid may be used. As the borate, soluble salts of these boric acids are preferably employed. Specifically, Na₂B₄O₇.10H₂O, NaBO₂.4H₂O, K₂B₄O₇.5H₂O, KBO₂, NH₄B₄O₉.3H₂O and NH₄BO₂ may, for example, be mentioned.

The dry amount of boric acid or a borate used in the coating dispersion is generally from 5 to 50 weight %, preferably from 10 to 30 weight %, as calculated as H₃BO₃ relative to the binder resin. If the content as calculated as H₃BO₃ is less than 5 weight % relative to the binder resin, it tends to be difficult to prevent formation of fine cracks during the drying operation or to increase the absorptivity. On the other hand, if the content as calculated as H₃BO₃ exceeds 50 weight % relative to the binder resin, the change with time of the viscosity of the coating dispersion tends to substantial, and the coating stability tends to poor. The ink-receiving layer preferably comprises from 0.05 to 5 g/m², more preferably from 0.1 to 2 g/m² of boric acid or borate.

In the present invention, the term “ink-jet recording material substantially free of thiocyanate” means an ink-jet recording material in which the thiocyanate compounds are absent or are present in an amount lower than 0.01% by weight on the basis of the weight of the porous ink-receiving layer.

Moreover, the ink-receiving layer of the recording material of the present invention preferably contains at least a surfactant. Preferred examples of surfactants include amphoteric surfactants, cationic surfactants, and non-ionic surfactants.

Examples of cationic surfactants include 2-vinylpyridine derivatives and poly-4-vinylpyridine derivatives. Examples of amphoteric surfactants include lauryl dimethyl aminoacetic acid betaine, 2-alkyl-N-carboxymethyl-N-hydroxyethyl imidazolinium betaine, propyldimethylaminoacetic acid betaine, polyoctylpolyaminoethyl glycine, and imidazoline derivatives. Useful examples of non-ionic surfactants include non-ionic fluorinated surfactants and non-ionic hydrocarbon surfactants. Examples of non-ionic hydrocarbon surfactants include ethers, such as polyoxyethylene nonyl phenyl ethers, polyoxyethylene octyl phenyl ethers, polyoxyethylene dodecyl phenyl ethers, polyoxyethylene alkyl allyl ethers, polyoxyethylene oleyl ethers, polyoxyethylene lauryl ethers, polyoxyethylene alkyl ethers, polyoxyalkylene alkyl ethers; esters, such as polyoxyethylene oleate, polyoxyethylene distearate, sorbitan laurate, sorbitan monostearate, sorbitan monooleate, sorbitan sesquioleate, polyoxyethylene monooleate, and polyoxyethylene stearate; and glycol surfactants. Specific examples of non-ionic surfactants include octylphenoxy polyethoxy ethanols, such as Triton™X-100, X-114, and X-405, available from Union Carbide Co., Danbury, Conn.; acetylenic diols such as 2,4,7,9-tetramethyl-5-decyl-4,7-diol and the like, such as Surfynol™GA and Surfynol™CT-136 available from Air Products & Chemicals Co., Allentown, Pa., trimethyl nonylpolyethylene-glycol ethers, such as Tergitol™TMN-10 (containing 10 oxyethylene units, believed to be of formula C₁₂H₂₅O(C₂H₄O)₅H), available from Union Carbide Co., Danbury, Conn.; non-ionic esters of ethylene oxide, such as Merpol™SH (believed to be of formula CH₃(CH₂)₂(OC₂H₄)₈OH), available from E.I. Du Pont de Nemours & Co., Wilmington, Del.; non-ionic esters of ethylene oxide and propylene oxide, such as Merpol™LFH (believed to be of formula CH₃(CH)ₙ(OC₂H₄)₈(OC₃H₆)₈OH, where n is an integer from about 12 to about 16), available from E.I. Du Pont de Nemours & Co., Wilmington, Del., and the like, as well as mixtures thereof. Non-limiting examples of non-ionic fluorinated surfactants include linear perfluorinated polyethoxylated alcohols (e.g., Zonyl™FSN, Zonyl™FSN-100, Zonyl™FSO, and Zonyl™FSO-100 available from DuPont Specialty Chemicals, Wilmihgton, Del.), fluorinated alkyl polyoxyethylene ethanols (e.g., Fluorad™FC-170C available from 3M, St. Paul, Minn.), fluorinated allyl alkoxylates (e.g., Fluorad™FC-171 available from 3M, St. Paul, Minn.), fluorinated alkyl esters (e.g., Fluorad™FC-430, FC-431, and FC-740 available from 3M, St. Paul, Minn.) and fluorine-substituted alkyl esters and perfluoroalkyl carboxylates (for example, the F-tergentseries manufactured by Neos Co., Ltd., the Lodyneseries manufactured by Ciba-Geigy, the Monflorseries manufactured by ICI, the Surfluonseries manufactured by Asahi Glass Co., Ltd., and the Unidyneseries manufactured by Daikin Industries, Ltd.). Preferred nonionic fluorocarbon surfactants include Zonyl™FSO, Fluorad™FC-170C, and Fluorad™FC-171.

The above mentioned surfactants are added to the coating dispersion in an amount from 0.1 td 1.0 g/l, preferably from 0.5 to 5 g/l. The ink-receiving layer comprises from 0.01 and 5 g/m² of said surfactants, preferably from 0.05 and 1 g/m².

The ink-receiving layer is formed by applying a coating dispersion comprising alumina particles, a binder resin, boric acid or a borate, and a color fading inhibitor compound of formula I onto a base material by means of a coater and then drying the base material.

In addition, a dispersant, a thickening agent, a pH adjustor, a lubricant, a fluidity modifier, a surface activator, waterproof agent, a mold-releasing agent, a whitening agent, an ultraviolet absorbing agent, an antioxidant, can be added- to the coating dispersion.

The support used in the ink-jet recording material of the invention includes any conventional support for ink jet recording sheet. As a support used in the invention, a transparent or opaque support can be used according to the final use of the ink jet recording sheet. As transparent support, any conventional support, such as a film or plate of polyester resins, cellulose acetate resins, acryl resins, polycarbonate resins, polyvinyl chloride resins, poly(vinylacetals), polyethers, polysulfonamides, polyamide resins, polyimide resins, cellophane or celluloid and a glass plate can be used in the present invention. The thickness of the transparent support is preferably from 10 to 200 mm. As the opaque support, any conventional one such as paper, coat paper, synthetic paper, resin-covered paper, pigment-containing opaque film or foaming film can be used in the invention. When the resin-coated paper is used as the base material, the ink-jet recording material according to the present invention can be provided as a recording material having the same feeling to the touch, stiffness and texture as those of a usual photoprint. Further, the recording material according to the present invention becomes very close to the usual photoprint because its ink-receiving layer has high surface gloss.

The base material may be subjected to a surface treatment such as a corona discharge treatment for improving its adhesiveness to the ink-receiving layer, or provided with an adhesion improving layer as an under coat. Further, a curl-preventing layer such as a resin layer or a pigment layer may be provided on the back surface of the base material or at a desired position thereof to prevent curling.

As a coating process, a blade coating system, air-knife coating system, roll coating system, brush coating system, gravure coating system, bar coating, extrusion system, slide coater system, curtain coating system, or the like may be used. The extrusion system and slide coater system are particularly preferred to obtain by one pass a thick coating of proper and uniform thickness. In particular, a slide coater, as described, for example, in U.S. Pat. No. 2,761,419, is a multilayer die composed of a pack of elements, where distribution cavities are formed between each pair of elements. Coating liquids are laterally or centrally fed in the distribution cavities and uniformly spread through a slot, at which end they flow down an inclined plane, stacking in a multilayer stack. At the end of the slide, at a short distance from the edge (about 100-500 microns), the liquid meets and coats the moving web.

The viscosity of the resulted dispersionis suitable for the use of a slide coater system where the coating solution is run onto a base material (plastic film or paper) in a laminar form. Then, the dispersion can be dried at a temperature lower than 60° C., preferably lower than 50° C., giving at the end a thick layer with a uniform surface.

According to another embodiment of the invention, the invention also refers to the use of an ink-jet recording material substantially free of thiocyanate compounds as described above to improve the gas resistance of images recorded on it.

The following examples will describe in particular the advantages of the present invention over the prior art.

### EXAMPLES

### Example 1

Sample 1 (reference). A micro-porous inkjet recording material was obtained by slide coating on the top of a 214 g/m² resin coated paper support a micro-porous layer comprising, as dry coverage per square meters, 43 g of Disperal™HP14 (an alumina hydrate manufactured by Condea Gmbh, Hamburg, Germany), 4.68 g of Airvol™523 (a polyvinyl alcohol manufactured by Air Products, Allentown, Pa., having a saponification degree of 88%, and a polymerization degree of 1,500), 1.31 g of acetic acid, 0.53 g of boric acid, 0.16 g of Triton™X-100 (a non-ionic surfactant available from Union Carbide Co., Danbury, Conn.) and 0.034 g of Zonyl™FSN-100 (a non-ionic fluorinated surfactant manufactured by DuPont Specialty Chemicals, Wilmington, Del.). The wet resulting coating was dried and the resulting micro-porous ink-receiving material prepared in roll was converted in A4 samples.

Sample 2 (comparison) was prepared as Sample 1, but the microporous ink-receiving material did not contain boric acid. The resulting material exhibited unacceptable cracking defects on surface of the porous layer which precluded any printing. For this reason, the results are not included in the following tables.

Sample 3 (comparison) was prepared as Sample 1, but the micro-porous layer additionally comprised 0.66 g/m² of potassium thiocyanate.

Sample 4 (comparison) was prepared as Sample 1, but the micro-porous layer additionally comprised 1 g/m² of potassium thiocyanate.

Sample 5 (comparison) was prepared as Sample 1, but the micro-porous layer additionally comprised 2.15 g/m² of compound A, commercially available as Tinuvin^{R}292 from Ciba Specialty Chemicals Inc, Basel, Switzerland.

Sample 6 (comparison) was prepared as Sample 1, but the micro-porous layer additionally comprised 2.15 g/m² of compound B, commercially available as Tinuvin^{R}123 from Ciba Specialty Chemicals Inc, Basel, Switzerland.

Sample 7 (comparison) was prepared as Sample 1, but the micro-porous layer additionally comprised 2.15 g/m² of compound C, commercially available as Tinuvin^{R}622 from Ciba Specialty Chemicals Inc, Basel, Switzerland.

Sample 8 (comparison) was prepared as Sample 1, but the micro-porous layer additionally comprised 2.15 g/m² of compound D, commercially available as Tinuvie^{R}440 from Ciba Specialty Chemicals Inc, Basel, Switzerland.

Sample 9 (comparison) was prepared as Sample 1, but the micro-porous layer additionally comprised 2.15 g/m² of compound E, commercially-available as Chimassorb^{R}119FL from Ciba Specialty Chemicals Inc, Basel, Switzerland.

Sample 10 (comparison) was prepared as Sample 1, but the micro-porous layer additionally comprised 2.15 g/m² of compound F, commercially available as Chimassorb^{R}944 from Ciba Specialty Chemicals Inc, Basel, Switzerland.

Sample 11 (comparison) was prepared as Sample 1, but the micro-porous layer additionally comprised 2.15 g/m² of compound G, commercially available as Chimassorb^{R}2020 from Ciba Specialty Chemicals Inc, Basel, Switzerland.

Sample 12 (comparison) was prepared as Sample 1, but the micro-porous layer additionally comprised 2.15 g/m² of compound H, commercially available as Irganox^{R} 1076 from Ciba Specialty Chemicals Inc, Basel, Switzerland.

Sample 13 (comparison) was prepared as Sample 1, but the micro-porous layer additionally comprised 2.15 g/m² of compound I, commercially available as Irganox^{R}1098 from Ciba Specialty Chemicals Inc, Basel, Switzerland.

Sample 14 (comparison) was prepared as Sample 1, but the micro-porous layer additionally comprised 2.15 g/m² of compound J, commercially available as Irganox^{R}1330 from Ciba Specialty Chemicals Inc, Basel, Switzerland.

Sample 15 (comparison) was prepared as Sample 1, but the micro-porous layer additionally comprised 2.15 g/m² of compound K, commercially available as Irganox^{R}1010 from Ciba Specialty Chemicals Inc, Basel, Switzerland.

Sample 16 (comparison) was prepared as Sample 1, but the micro-porous layer, additionally comprised 2.15 g/m² of compound L, commercially available as Irganox^{R}E201 from Ciba Specialty Chemicals Inc, Basel, Switzerland.

Sample 17 (invention) was prepared as Sample 1, but the micro-porous layer additionally comprised 2.15 g/m² of Compound (1) of the present invention, commercially available as Tinuvin^{R}144 from Ciba Specialty Chemicals Inc, Basel, Switzerland.

Samples 1 and 3 to 17 have been tested according to the following procedure. A solid image pattern including 7 patches (cyan, magenta, yellow, red, green, blue and black patches) was printed-on the test sheet by a model Deskjet 970 ink-jet printer (manufactured by Hewlett-Packard Co., Palo Alto, Calif.) with the original ink tanks made by Hewlett-Packard. The reflection density of recorded patches area has been measured for each single color cyan, magenta, yellow and for each component of the red, green, blue and black area with a densitometer, model TR 1224 (manufactured by Macbeth, a division of Kollmorgen Instrument Corp., Newburgh, N.Y.). The patch area exhibiting a density near 1.00 has been selected for each single color cyan, magenta and yellow; on the other hand, for the red, green and blue composite colors, it has been considered each respective two components to choose the respective density 1.00 area; finally, the three components to choose the respective density 1.00 area have been considered for the black composite color. The samples have been submitted to a 2 Klux intensity fluorescent light exposure, at 50% relative humidity and 23° C. The air composition has been maintained stable during all the test, in particular for the oxygen and H₂S, SO₂, NO₂ and 03 gases present in little amounts in the ground. The recorded sample surface has been maintained free of any physical protection to allow the natural gas circulation. After incubation, the density has been measured for each selected area in which an initial density near 1.00 had been measured; consequently, the gas image resistance can be evaluated.

Gas image resistance evaluation. The evaluation was performed considering the rate of density lost calculated with the formula:
Lost rate (%) [(DP_{AI}−DU_{AI})−(DP_{BI}−DU_{BI})]×100(DP_{BI}−DU_{BI})
in which
DP_{MI}=Density of Printed area After Incubation
DU_{AI}=Density of Unprinted area After Incubation
DP_{BI}=Density of Printed area Before Incubation
DP_{BI}=Density of Unprinted area Before Incubation

The image resistance of a sample was evaluated by average of the density lost rate for all the 7 colors (cyan, magenta, yellow, red, green, blue and black):
Avg. Lost rate (%)=[C+M+Y+(M_{red}+Y_{red})+(C_{green}+Y_{green})+(C_{blue}+M_{blue})+(C_{black}+M_{black}+Y_{black})]/12
with
C=lost rate % of Cyan
M=lost rate % of Magenta
Y=lost rate % of Yellow
M_{red}=lost rate % of Magenta component in red area
Y_{red}=lost rate % of Yellow component in red area
C_{green}=lost rate % of Cyan component in green area
Y_{green}=lost rate % of Yellow component in green area
C_{blue}=lost rate % of Cyan component in blue area
M_{blue}=lost rate % of Magenta component in blue area
C_{black}=lost rate % of Cyan component in black area
M_{black}=lost rate % of Magenta component in black area
Y_{black}=lost rate % of Yellow component in black area

The optical density lost rate percentage data obtained from the procedure described above determine the gas resistance fading of the ink-jet recording materials. Table 1 and Table 2 report the results in terms of optical density lost rate percentage after that samples 1 and 3 to 17 have been stored for, respectively, 7 and 24 incubation weeks.

TABLE 1

| | | | | | Optical Density lost rate %: 7 Incubation weeks | | | | | | | | | | | | |
|---|---|---|---|---|---|---|---|---|---|---|---|---|---|---|---|---|---|
| Samples | | Additives/dry coverage | | | C | M | Y | M(R) | Y(R) | C(G) | Y(G) | C(B) | M(B) | C(Bk) | M(Bk) | Y(Bk) | Avg. |
| 1 | (reference) | — | — | | −53.3 | −61.7 | −26.8 | −60.2 | −29.3 | −47.9 | −28.7 | −52.6 | −59.5 | −49.0 | −59.1 | −29.9 | −46.5 |
| 2 | (comparison) | no boric acid | | | | | | | | | | | | | | | KO |
| 3 | (comparison) | KSCN | 0.66 | g/m² | −12.0 | −11.0 | −2.0 | −8.3 | −0.9 | −11.0 | −0.9 | −21.1 | −8.2 | −13.9 | −6.1 | −0.9 | −8.0 |
| 4 | (comparison) | KSCN | 1 | g/m² | −12.4 | −8.8 | −5.0 | −8.2 | −5.2 | −8.1 | −6.2 | −15.5 | −7.1 | −9.7 | −8.2 | −4.0 | −8.2 |
| 5 | (comparison) | A | 2.15 | g/m² | −37.5 | −18.8 | −21.0 | −12.1 | −13.5 | −30.0 | −15.1 | −32.8 | −16.3 | −29.4 | −14.9 | −16.5 | −21.5 |
| 6 | (comparison) | B | 2.15 | g/m² | −51.1 | −54.4 | −26.9 | −50.5 | −26.7 | −41.5 | −26.8 | −47.2 | −54.7 | −43.1 | −53.1 | −27.8 | −42.0 |
| 7 | (comparison) | C | 2.15 | g/m² | −41.3 | −42.6 | −23.7 | −47.0 | −23.5 | −37.8 | −24.5 | −41.0 | −50.0 | −38.5 | −49.5 | −24.5 | −37.0 |
| 8 | (comparison) | D | 2.15 | g/m² | −41.3 | −42.6 | −23.7 | −47.0 | −23.5 | −37.8 | −24.5 | −41.0 | −50.0 | −38.5 | −49.5 | −24.5 | −37.0 |
| 9 | (comparison) | E | 2.15 | g/m² | −60.5 | −20.4 | −16.2 | −13.3 | −11.9 | −63.7 | −32.2 | −63.4 | −48.8 | −59.9 | −43.1 | −23.7 | −38.1 |
| 10 | (comparison) | F | 2.15 | g/m² | −61.5 | −18.7 | −15.5 | −11.9 | −10.8 | −61.3 | −30.5 | −62.2 | −45.4 | −64.0 | −47.5 | −21.4 | −37.6 |
| 11 | (comparison) | G | 2.15 | g/m² | −48.6 | −17.0 | −17.9 | −15.6 | −17.4 | −38.2 | −28.1 | −40.7 | −38.6 | −36.0 | −32.2 | −21.6 | −29.3 |
| 12 | (comparison) | H | 2.15 | g/m² | −32.0 | −34.9 | −27.2 | −37.2 | −24.5 | −27.6 | −26.8 | −30.3 | −37.9 | −30.5 | −40.9 | −25.9 | −31.3 |
| 13 | (comparison) | I | 2.15 | g/m² | −21.7 | −20.3 | −25.3 | −18.7 | −16.5 | −15.7 | −24.1 | −21.1 | −19.8 | −15.3 | −22.4 | −20.5 | −20.1 |
| 14 | (comparison) | J | 2.15 | g/m² | −21.5 | −19.9 | −19.7 | −20.3 | −17.5 | −19.1 | −23.2 | −27.6 | −26.2 | −27.8 | −26.9 | −20.0 | −22.5 |
| 15 | (comparison) | K | 2.15 | g/m² | −24.7 | −27.0 | −23.9 | −27.4 | −21.4 | −19.9 | −24.6 | −23.7 | −30.2 | −22.6 | −31.5 | −22.3 | −24.9 |
| 16 | (comparison) | L | 2.15 | g/m² | −17.4 | −7.9 | −20.9 | −7.1 | −14.3 | −14.9 | −20.0 | −18.2 | −11.7 | −16.3 | −10.7 | −17.0 | −14.7 |
| 17 | (invention) | (1) | 2.15 | g/m² | −12.1 | −12.6 | −8.1 | −6.7 | −5.0 | −9.4 | −5.3 | −11.5 | −6.7 | −10.8 | −7.1 | −5.3 | −8.4 |

TABLE 2

| | | | | | Optical Density lost rate %: 24 Incubation weeks | | | | | | | | | | | | |
|---|---|---|---|---|---|---|---|---|---|---|---|---|---|---|---|---|---|
| Samples | | Additives/dry coverage | | | C | M | Y | M(R) | Y(R) | C(G) | Y(G) | C(B) | M(B) | C(Bk) | M(Bk) | Y(Bk) | Avg. |
| 1 | (reference) | — | — | | −86.7 | −95.7 | −34.0 | −91.4 | −43.5 | −87.2 | −37.6 | −87.7 | −92.4 | −87.5 | −89.8 | −44.8 | −73.2 |
| 2 | (comparison) | no boric acid | | | | | | | | | | | | | | | KO |
| 3 | (comparison) | KSCN | 0.66 | g/m² | −55.0 | −60.1 | −15.7 | −57.1 | −18.9 | −63.2 | −15.5 | −75.7 | −59.4 | −75.5 | −64.9 | −25.2 | −48.8 |
| 4 | (comparison) | KSCN | 1 | g/m² | −56.3 | −58.5 | −14.0 | −58.1 | −24.9 | −59.5 | −20.9 | −63.9 | −57.7 | −57.5 | −53.3 | −26.3 | −45.9 |
| 5 | (comparison) | A | 2.15 | g/m² | −79.2 | −60.4 | −27.0 | −49.5 | −30.2 | −67.8 | −29.0 | −76.2 | −59.3 | −76.5 | −59.6 | −36.3 | −54.2 |
| 6 | (comparison) | B | 2.15 | g/m² | −86.4 | −86.4 | −31.2 | −80.0 | −38.1 | −81.9 | −32.0 | −85.4 | −83.7 | −84.4 | −80.6 | −38.1 | −67.3 |
| 7 | (comparison) | C | 2.15 | g/m² | −73.4 | −84.0 | −24.5 | −75.2 | −30.6 | −69.6 | −27.7 | −74.4 | −78.7 | −67.9 | −72.2 | −30.4 | −59.0 |
| 8 | (comparison) | D | 2.15 | g/m² | −85.4 | −89.1 | −29.8 | −83.8 | −40.6 | −84.4 | −33.7 | −85.1 | −85.5 | −86.5 | −83.9 | −41.5 | −69.1 |
| 9 | (comparison) | E | 2.15 | g/m² | −69.2 | −42.6 | −34.1 | −39.2 | −33.6 | −65.1 | −40.9 | −64.9 | −64.0 | −62.6 | −56.2 | −37.0 | −50.8 |
| 10 | (comparison) | F | 2.15 | g/m² | −58.6 | −42.6 | −32.7 | −46.7 | −36.8 | −58.1 | −45.9 | −48.3 | −55.1 | −51.9 | −59.5 | −37.2 | −47.8 |
| 11 | (comparison) | G | 2.15 | g/m² | −66.7 | −52.6 | −34.0 | −44.3 | −36.8 | −66.1 | −41.4 | −61.7 | −67.2 | −67.2 | −58.0 | −39.5 | −53.0 |
| 12 | (comparison) | H | 2.15 | g/m² | −61.9 | −65.5 | −33.6 | −65.8 | −36.0 | −60.5 | −34.3 | −62.5 | −66.8 | −64.8 | −66.9 | −37.3 | −54.7 |
| 13 | (comparison) | I | 2.15 | g/m² | −55.6 | −41.2 | −32.3 | −36.8 | −24.6 | −43.9 | −33.2 | −54.9 | −41.7 | −42.7 | −48.0 | −33.4 | −40.7 |
| 14 | (comparison) | J | 2.15 | g/m² | −50.4 | −44.7 | −30.9 | −45.2 | −30.1 | −48.1 | −38.7 | −64.2 | −54.6 | −69.6 | −80.8 | −37.7 | −49.6 |
| 15 | (comparison) | K | 2.15 | g/m² | −56.1 | −52.8 | −29.7 | −49.7 | −29.9 | −47.8 | −32.8 | −57.6 | −54.1 | −51.9 | −56.3 | −33.8 | −46.0 |
| 16 | (comparison) | L | 2.15 | g/m² | −42.6 | −29.0 | −32.8 | −28.5 | −24.5 | −44.0 | −39.0 | −45.9 | −43.5 | −45.6 | −42.8 | −31.5 | −37.5 |
| 17 | (invention) | (1) | 2.15 | g/m² | −34.3 | −39.8 | −16.3 | −15.4 | −6.9 | −19.8 | −8.5 | −26.2 | −14.4 | −20.7 | −13.3 | −8.5 | −18.7 |

As shown by Tables 1 and 2, reference Sample 1, with no additives, presented a serious deterioration of the color with an average rate lost close to 50% of the initial optical density after 7 incubation weeks only, and much higher after 24 incubation weeks. Comparison Sample 2, not containing boric acid exhibited unacceptable cracking defects on surface of the porous layer which precluded any printing. Comparison Samples 3 and 4, containing different amount of thiocyanate salts as additive, both allowed to decrease the color fading rate below 10% after 7 incubation weeks, but they were not able to preserve color for long term conservation; in fact, the lost in optical density after 24 incubation weeks of both comparison samples 3 and 4 was too high, close to 50%. Comparison Samples 5 to 11, containing sterically hindered amine compounds different from the color fading inhibitor compounds used in the present invention due to the absence of sterically hindered phenol moieties in their chemical formulas, showed an unacceptable lost in density due to the degradation of colored matter, both for short and long term storage. Also comparison Samples 12 to 16, containing conventional phenolic antioxidants different from the color fading inhibitor compounds used in the present invention due to the absence of sterically hindered amine moieties in their chemical formulas, showed insufficient improvement in color fading. On the other hand, Sample 17, containing Compound (1) used in the present invention with sterically hindered phenol and sterically hindered amine moieties in the same formula, showed a moderate average lost in density, even after long term storage.

### Example 2

Sample 18 (reference) was prepared as Sample 1.

Sample 19 (comparison) was prepared as Sample 1, but the micro-porous layer additionally comprised 2.15 g/m² of compound M, commercially available as Tinuvin^{R}765 from Ciba Specialty Chemicals Inc, Basel, Switzerland.

Sample 20 (comparison) was prepared as Sample 1, but the micro-porous layer additionally comprised 2.15 g/m² of compound H, commercially available as Irganox^{R}1076 from Ciba Specialty Chemicals Inc, Basel, Switzerland.

Sample 21 (comparison) was prepared as Sample 1, but the micro-porous layer additionally comprised 1.075 g/m² of compound M and 1.075 g/m² of compound H, both commercially available as, respectively, Tinuvin^{R}765 and Irganox^{R}1076 from Ciba Specialty Chemicals Inc, Basel, Switzerland.

Sample 22 (invention) was prepared as Sample 1, but the micro-porous layer additionally comprised 2.15 g/m² of Compound (1) of the present invention, commercially available as Tinuvin^{R}144 from Ciba Specialty Chemicals Inc, Basel, Switzerland.

Sample 23 (comparison) was prepared as Sample 1, but the micro-porous layer additionally comprised 2.15 g/m² of Compound (1) of the present invention, commercially available as Tinuvin^{R}144 from Ciba Specialty Chemicals Inc, Basel, Switzerland and 2.0 g/m² of potassium thiocyanate

Samples 18 to 23 have been tested according to the procedure described in Example 1, using a model PhotoSmart 1218 ink-jet printer (manufactured by Hewlett-Packard Co., Palo Alto, Calif.). The samples have been submitted to a 500 lux intensity fluorescent light exposure, at 30% relative humidity and 23° C. Table 3 and Table 4 report the results in terms of optical density lost rate percentage after that samples 18 to 23 have been stored for, respectively, 3 and 12 incubation weeks.

TABLE 3

| | | | | | Optical Density lost rate %: 3 incubation weeKs | | | | | | | | | | | | | |
|---|---|---|---|---|---|---|---|---|---|---|---|---|---|---|---|---|---|---|
| Samples | | Additives-dry coverage | | | C | M | Y | M(R) | Y(R) | C(G) | Y(G) | C(B) | M(B) | C(Bk) | M(Bk) | Y(Bk) | Avg. | DY |
| 18 | (refer- | — | — | | −11.0 | −10.5 | −26.5 | −8.2 | −21.6 | −8.7 | −26.3 | −11.6 | −13.5 | −9.2 | −10.3 | −19.8 | −14.8 | 0.01 |
| | ence) | | | | | | | | | | | | | | | | | |
| 19 | (compar- | M | 2.15 | g/m² | −30.5 | −6.1 | −10.2 | −5.4 | −8.3 | −25.0 | −24.7 | −30.7 | −12.6 | −26.1 | −9.9 | −15.6 | −17.1 | 0.01 |
| | ison) | | | | | | | | | | | | | | | | | |
| 20 | (compar- | H | 2.15 | g/m² | −11.6 | −8.2 | −28.3 | −6.5 | −23.5 | −8.7 | −28.4 | −12.2 | −8.4 | −5.4 | −4.5 | −20.2 | −13.8 | 0.10 |
| | ison) | | | | | | | | | | | | | | | | | |
| 21 | (compar- | M + H | 1.075 + | g/m² | −26.4 | −3.1 | −21.6 | 1.1 | −17.9 | −18.7 | −33.0 | −24.4 | −7.4 | −20.0 | −4.3 | −26.3 | −16.8 | 0.15 |
| | ison) | | 1.075 | | | | | | | | | | | | | | | |
| 22 | (inven- | (1) | 2.15 | g/m² | −7.9 | 1.1 | −4.0 | 0.0 | −1.0 | −3.3 | −7.1 | −6.7 | −1.1 | 0.0 | 1.1 | 1.0 | −2.3 | 0.00 |
| | tion) | | | | | | | | | | | | | | | | | |
| 23 | (compar- | (1) + | 2.15 + | g/m² | −1.3 | −0.7 | −6.7 | −1.4 | −5.7 | −2.7 | −5.0 | −3.4 | −2.4 | −3.2 | −3.0 | −5.2 | −3.4 | 0.02 |
| | ison) | KSCN | 2.00 | | | | | | | | | | | | | | | |

TABLE 4

| | | | | | Optical Density lost rate %: 12 incubation weeks | | | | | | | | | | | | | |
|---|---|---|---|---|---|---|---|---|---|---|---|---|---|---|---|---|---|---|
| Samples | | Additives-dry coverage | | | C | M | Y | M(R) | Y(R) | C(G) | Y(G) | C(B) | M(B) | C(Bk) | M(Bk) | Y(Bk) | Avg. | DY |
| 18 | (refer- | — | — | | −33.0 | −33.7 | −29.6 | −35.1 | −27.8 | −33.7 | −30.3 | −36.8 | −34.4 | −32.7 | −37.1 | −26.0 | −32.5 | 0.02 |
| | ence) | | | | | | | | | | | | | | | | | |
| 19 | (compar- | M | 2.15 | g/m² | −45.3 | −26.3 | −26.5 | −21.5 | −22.9 | −41.7 | −26.8 | −46.6 | −35.8 | −45.7 | −33.0 | −20.8 | −32.7 | 0.00 |
| | ison) | | | | | | | | | | | | | | | | | |
| 20 | (compar- | H | 2.15 | g/m² | −37.9 | −30.6 | −28.3 | −27.2 | −23.5 | −32.6 | −28.4 | −37.8 | −32.6 | −33.7 | −31.5 | −23.2 | −30.6 | 0.01 |
| | ison) | | | | | | | | | | | | | | | | | |
| 21 | (compar- | M + H | 1.075 + | g/m² | −39.6 | −41.7 | −41.2 | −35.2 | −49.5 | −35.2 | −41.0 | −38.9 | −37.9 | −36.8 | −37.0 | −31.3 | −38.8 | 0.58 |
| | ison) | | 1.075 | | | | | | | | | | | | | | | |
| 22 | (inven- | (1) | 2.15 | g/m² | −15.7 | −17.4 | −18.0 | −18.3 | −16.5 | −14.3 | −19.2 | −18.0 | −17.2 | −13.0 | −13.3 | −10.4 | −15.9 | 0.01 |
| | tion) | | | | | | | | | | | | | | | | | |
| 23 | (compar- | (1) + | 2.15 + | g/m² | −25.3 | −7.6 | −17.0 | −10.9 | −12.4 | −17.2 | −16.5 | −26.1 | −12.3 | −16.3 | −12.5 | −14.9 | −15.7 | 0.13 |
| | ison) | KSCN | 2.00 | | | | | | | | | | | | | | | |

Tables 3 and 4 show that the blend of sterically hindered amine compounds and sterically hindered phenol compounds (comparison Sample 21) does not give an improvement in color fading respect to single sterically hindered amine compound (comparison Sample 19) or single sterically hindered phenol compound (comparison Samples 20) or respect to the reference Sample 18 without any additives, too. Comparison Sample 23, containing a mixture of potassium thiocyanate and the Compound (1) used in the present invention, showed a moderate lost of optical density (comparable to the same value related to invention Sample 22, containing the Compound (1) used in the present invention only), but showed also an unacceptable yellowing of unprinted area, as shown by column DY, which reports the density changes for yellow component of a white unprinted area of each sample. This fact is particularly visible after 12 incubation weeks. On the contrary, invention Sample 22, containing the Compound (1) used in the present invention only, showed very stable values related to yellowing, in addition to a moderate lost of optical density, even after long term storage.

Formulas of chemicals used in the examples

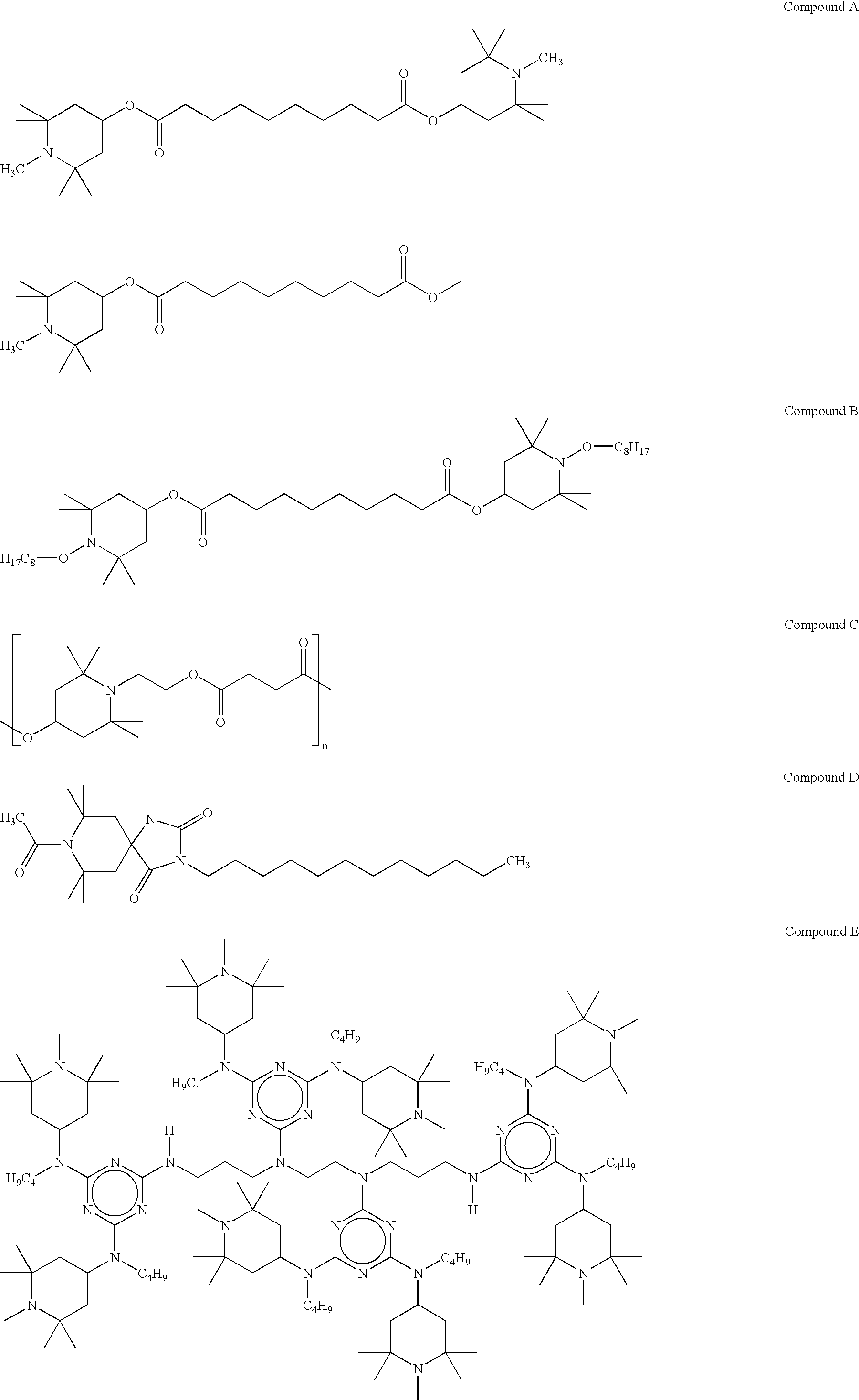

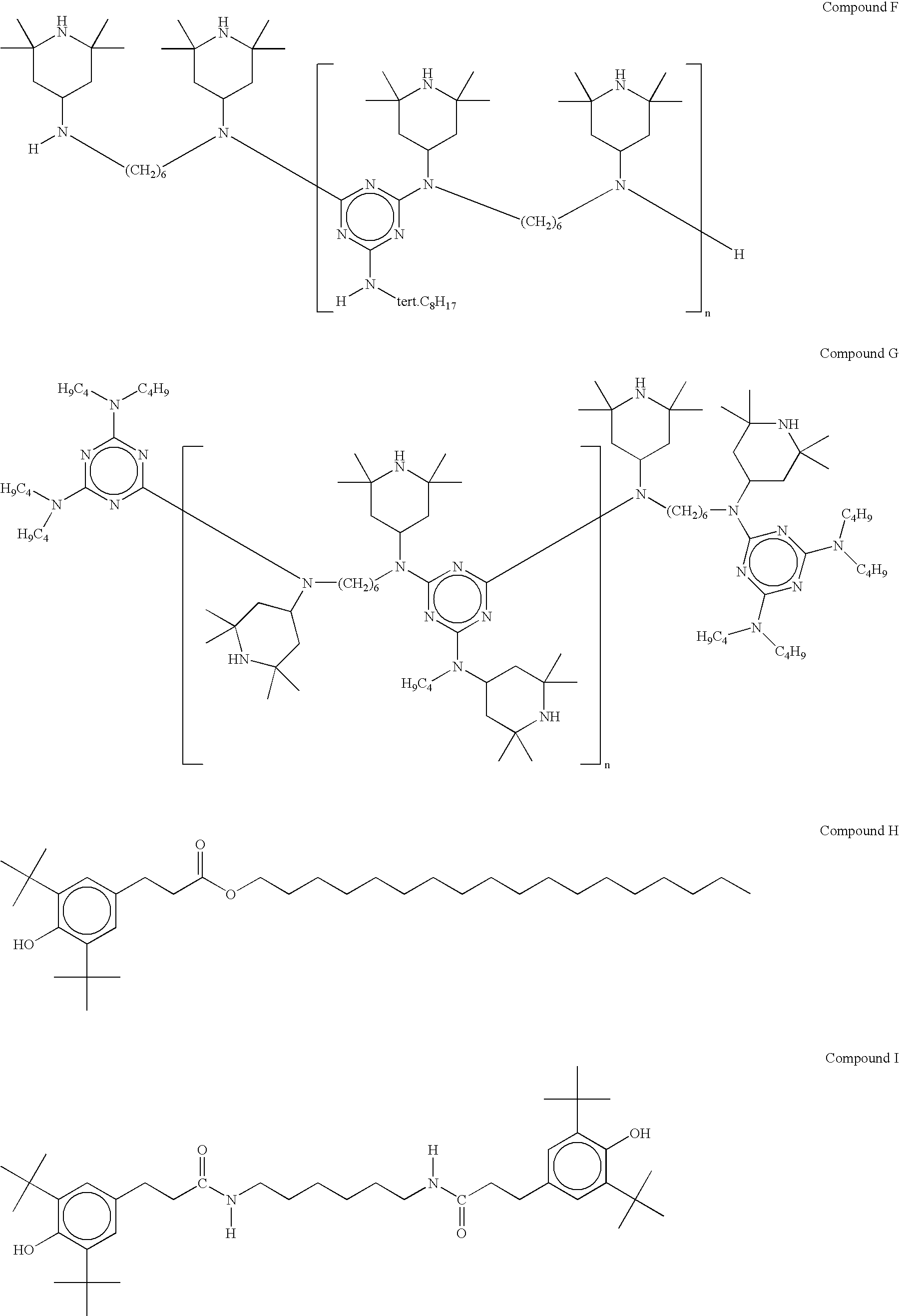

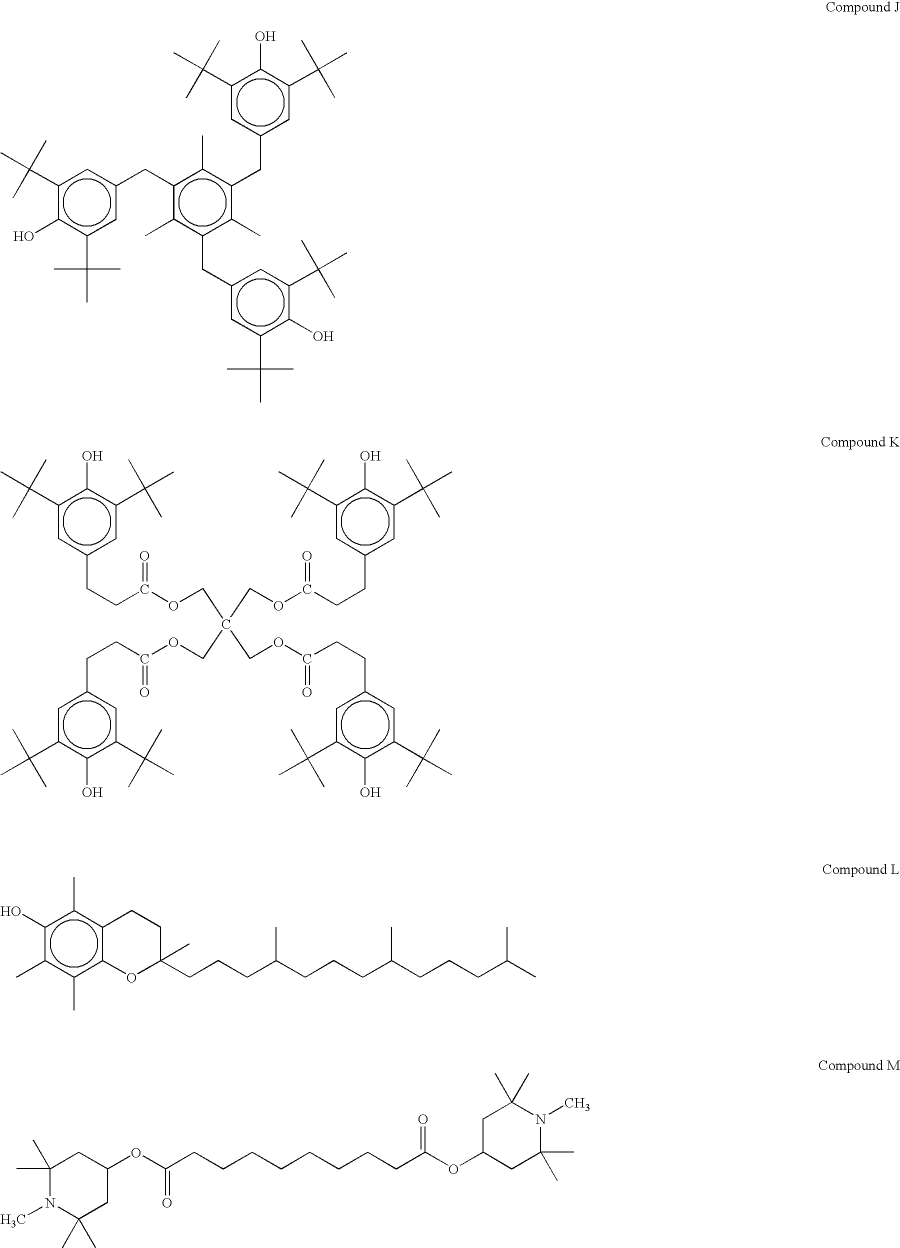

1. Ink-jet recording material having at least an ink-receiving layer comprising alumina particles, a binder resin, boric acid or borate and a color fading inhibitor compound of the following Formula I: 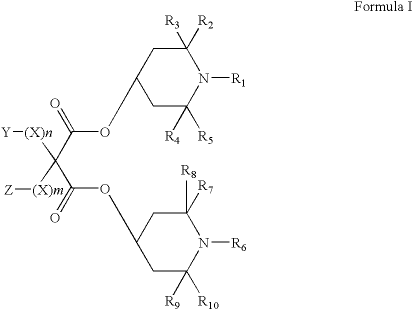
wherein R₁ to R₁₀, being the same or different, each are an alkyl group having from 1 to 5 carbon atoms; X is a divalent linking group; m and n, equal or different, are 0, 1 or 2; Z is Y or is an alkyl group having from 1 to 12 carbon atoms, and Y is represented by formula II, 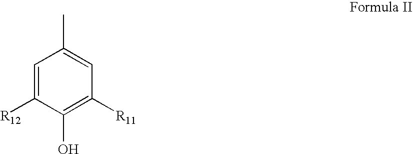
wherein R₁₁ and R₁₂ each being an alkyl group having from 1 to 6 carbon atoms, said ink-jet recording material being substantially free of thiocyanate compounds.

2. Ink-jet recording material according to claim 1, wherein the color fading inhibitor compound is represented by formula: 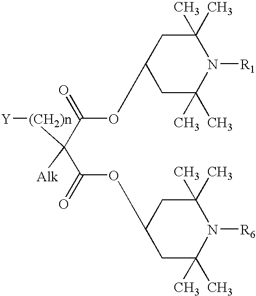
wherein, Y, R₁ and R₂ are as above and Alk is an alkyl group having from 1 to 12 carbon atoms.

3. Ink-jet recording material according to claim 1, wherein the color fading inhibitor compound is represented by formulas:

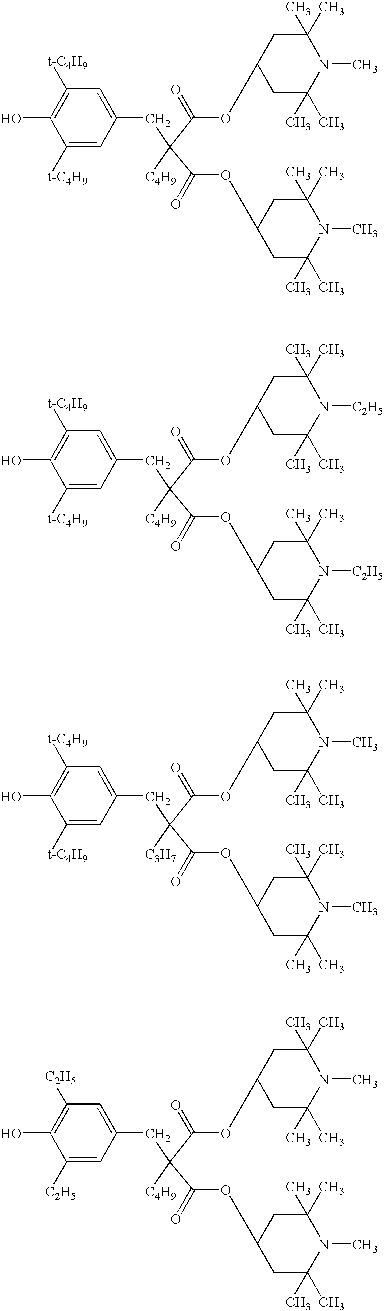

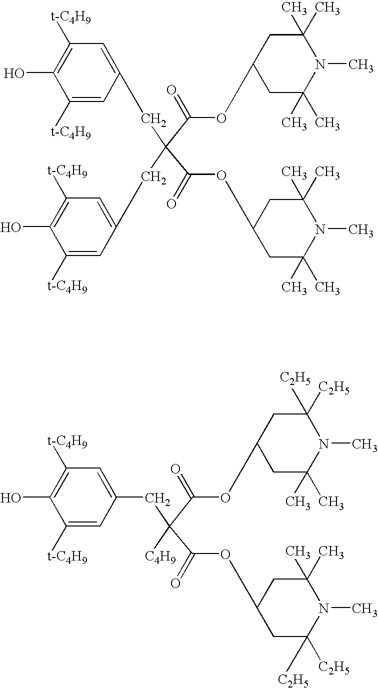

4. An ink-jet recording material according to claim 1, wherein the amount of said color fading inhibitor compound is preferably from 0.5 to 15 weight %, respect to the amount of alumina particles present in the ink-jet receiving layer.

5. An ink-jet recording material according to claim 1, wherein the alumina particles are alumina hydrate.

6. An ink-jet recording material according to claim 5, wherein the alumina hydrate has a boehmite or pseudo-boehmite structure of formula Al₂O₃.nH₂O, wherein n is a number from 1.0 to 2.0.

7. An ink-jet recording material according to claim 1, wherein the average particle diameter of the alumina particles is in the range from 10 to 200 nm.

8. An ink-jet recording material according to claim 1, wherein the average pore radius of the alumina particles is in the range from 2 to 100 nm.

9. An ink-jet recording material according to claim 1, wherein the alumina particles have a pore radius maximum within a range of from 9 to 12 nm in a pore radius distribution of the fine powder material and a total volume of pores having radii not exceeding 5 nm is not more than 10% of a volume of all pores of the fine powder material.

10. An ink-jet recording material according to claim 1, wherein the binder resin is a polyvinyl alcohol.

11. An ink-jet recording material according to Claim 10, wherein the polyvinyl alcohol has a saponification degree lower than 90%.

12. An inkjet recording material according to claim 10, wherein the polyvinyl alcohol has a polymerization degree lower than 1500.

13. An ink-jet recording material according to claim 1, wherein soluble salts of boric acids are used.

14. An ink-jet recording medium according to claim 1, wherein said ink-receiving layer additionally comprises at least one surfactant.

15. Use of an ink-jet recording material substantially free of thiocyanate compounds as described in claim 1 to 14 to improve the gas resistance of images recorded on it.

16. An inkjet recording microporous material showing an optical density average lost percentage lower than 20% after 24 weeks of exposition to air atmosphere under 2 Klux intensity fluorescent light exposure, at 50% relative humidity, and at 23° C.
